(19) United States
(12) Patent Application Publication
(10) Pub. No.: US 2025/0066593 A1
(43) Pub. Date: Feb. 27, 2025

(54) BLENDED POLYPROPYLENE COMPOSITION

(71) Applicant: SABIC GLOBAL TECHNOLOGIES B.V., Bergen op Zoom (NL)

(72) Inventors: Junhua ZHANG, Etten-Leur (NL); Dimphna Johanna, Maria VAN BEEK, Sittard (NL); Johannes Peter, Antonius MARTENS, Geleen (NL); Rob DONNERS, Brunssum (NL)

(21) Appl. No.: 18/722,101

(22) PCT Filed: Dec. 16, 2022
(86) PCT No.: PCT/EP2022/086269

§ 371 Date: Jun. 20, 2024

(30) Foreign Application Priority Data
Dec. 21, 2021 (EP) 21216499.0

(51) Int. Cl. C08L 23/12; C08J 11/06; C08K 3/34

(52) U.S. Cl. CPC C08L 23/12; C08J 11/06; C08K 3/34; C08J 2323/12; C08L 2205/025; C08L 2205/035; C08L 2207/02; C08L 2207/20

(57) ABSTRACT

A process for making a blended composition includes: i) obtaining (A) a recycled polypropylene composition from a waste plastic material,
ii) melt-mixing (A) with (B) a heterophasic propylene copolymer and (C) an inorganic filler, wherein (B) consists of (al) a propylene-based matrix consisting of a propylene homopolymer/copolymer consisting of at least 90 wt % of propylene monomer units and at most 10 wt % of ethylene and/or α-olefin monomer units, and (a2) a dispersed ethylene-α-olefin copolymer, copolymer (B) has a xylene soluble content of 12 to 27 wt %, an MRI at 230° C./2.16 kg of 5.6 to 65 dg/min, wherein the recycled composition includes at least 90 wt % a propylene-based polymer, has an ash content of less than 10 wt %, an MFI at 230° C./2.16 kg of 15 to 100 dg/min, an Izod impact strength (23° C.) of 2.0 to 5.0 kJ/m2, and a flexural modulus (23° C.) of 1500 to 2000 MPa.

### CROSS REFERENCE TO RELATED APPLICATIONS

This application is a National Stage application of PCT/EP2022/086269, filed Dec. 16, 2022, which claims the benefit of European Application No. 21216499.0, filed Dec. 21, 2021, both of which are incorporated by reference in their entirety herein.

### BACKGROUND

The present invention relates to a process for making a blended polypropylene composition and the composition obtainable thereby.

Compositions comprising a heterophasic propylene copolymer and an inorganic filler are widely used for applications requiring good mechanical properties such as impact strength. Certain applications require not only mechanical properties but also aesthetic quality. Aesthetic quality may be determined from so-called tiger stripes.

For example, WO2021130122A1 discloses a composition comprising two types of heterophasic propylene copolymers, an inorganic filler and an HDPE or an elastomer. The composition has a high heat deflection temperature and good tiger stripe performance. While the known composition is useful in various applications, there is still a need for a new composition with desired properties.

### SUMMARY

It is an objective of the present invention to provide a process in which the above-mentioned and/or other needs are met.

Accordingly, the present invention provides a process for making a blended composition, comprising the steps of:
i) processing a waste plastic material derived from post-consumer and/or post-industrial waste to obtain (A) a recycled composition,
ii) melt-mixing the recycled composition with (B) a heterophasic propylene copolymer and (C) an inorganic filler,
wherein the heterophasic propylene copolymer consists of (a1) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (a2) a dispersed ethylene-α-olefin copolymer, wherein the sum of the total amount of propylene-based matrix and total amount of the dispersed ethylene-α-olefin copolymer in the heterophasic propylene copolymer is 100 wt %,
the heterophasic propylene copolymer has a xylene soluble part with respect to the heterophasic propylene copolymer as determined by ISO16152:2005 of 12 to 27 wt % and
the heterophasic propylene copolymer has a melt flow index as determined by ISO1133-1:2011 at 230° C. with 2.16 kg load of 5.6 to 65 dg/min,
wherein the recycled composition comprises a propylene-based polymer at an amount of at least 90 wt % with respect to the recycled composition,
the recycled composition has an ash content as determined by ISO 3451 of less than 10 wt % with respect to the recycled composition,
the recycled composition has a melt flow index as determined by ISO1133-1:2011 at 230° C. with 2.16 kg load of 15 to 100 dg/min,
the recycled composition has an Izod impact strength as determined by ISO180/1A (parallel) at 23° C. of 2.0 to 5.0 kJ/m2 and
the recycled composition has a flexural modulus as determined by ISO178 (parallel) at 23° C. of 1500 to 2000 MPa.

It was surprisingly found that mixing the specific type of the recycled composition with an inorganic filler-filled composition comprising the specific type of the heterophasic propylene copolymer according to the invention results in an improved esthetical performance (tiger stripes) at a low cost.

### DETAILED DESCRIPTION

### Process for Making Blended Composition

The process according to the invention comprises the steps of
i) processing a waste plastic material derived from post-consumer and/or post-industrial waste to obtain (A) a recycled composition and
ii) melt-mixing the recycled composition with (B) a heterophasic propylene copolymer and (C) an inorganic filler.

In step i), post-consumer and/or post-industrial waste is processed by known methods involving e.g. washing, sorting and/or grinding to obtain the recycled composition. The recycled composition obtained by step i) may be in the form of pellets.

In step ii), the so-obtained recycled composition and the heterophasic propylene copolymer and the inorganic filler and optionally further additives are melt-mixed by using any suitable means to obtain the blended composition according to the invention.

Preferably, the blended composition of the invention is made in a form that allows easy processing into a shaped article in a subsequent step, like in pellet or granular form.

Preferably, the blended composition of the invention is in pellet or granular form as obtained by mixing all components in an apparatus like an extruder; the advantage being a composition with homogeneous and well-defined concentrations of the additives.

### (A) Recycled Composition

The recycled composition used in the present invention is obtained by processing a waste plastic material derived from post-consumer and/or post-industrial waste, preferably derived from post-industrial waste, by known methods involving e.g. washing, sorting and/or grinding.

The recycled composition comprises a propylene-based polymer at an amount of at least 90 wt % with respect to the recycled composition. Herein, a propylene-based polymer is understood as a propylene homopolymer, a propylene copolymer including random copolymers and (multi)block copolymers or a heterophasic propylene copolymer, having propylene monomer units at an amount of at least 50 wt %, for example at least 80 wt %.

The waste plastic material may comprise substantially the same amount of the propylene-based polymer as the recycled composition. The waste plastic material may comprise a propylene-based polymer at an amount of at least 90 wt % with respect to the waste plastic material.

The recycled composition has an ash content as determined by ISO 3451 of less than 10 wt % with respect to the recycled composition, preferably at most 8 wt %, at most 6 wt %, at most 5 wt %, at most 3 wt % or at most 1 wt %. The low ash content may lead to a better aesthetical quality and allow better control of the amount of the inorganic material in the blended composition of the invention.

The recycled composition has a melt flow index as determined by ISO1133-1:2011 at 230° C. with 2.16 kg load of 15 to 100 dg/min, preferably 20 to 100 dg/min, for example 21 to 80 dg/min, 22 to 60 dg/min or 23 to 50 dg/min.

Preferably, the ratio of the melt flow index as determined by ISO1133-1:2011 at 230° C. with 2.16 kg load of the recycled composition to the melt flow index as determined by ISO1133-1:2011 at 230° C. with 2.16 kg load of the propylene-based matrix of the heterophasic propylene polymer is 0.1 to 5.0, for example 0.1 to 1.0, preferably at least 0.20, more preferably at least 0.25, more preferably at least 0.30.

The recycled composition has an Izod impact strength as determined by ISO180/1A (parallel) at 23° C. of 2.0 to 5.0 kJ/m², for example 2.5 to 4.0 kJ/m².

The recycled composition has a flexural modulus as determined by ISO178 (parallel) at 23° C. of 1500 to 2000 MPa, for example 1600 to 1900 MPa.

This results in the blended composition according to the invention having good mechanical properties.

Preferably, the amount of the recycled composition with respect to the blended composition according to the invention is 10 to 90 wt %, 15 to 70 wt %, 20 to 60 wt %, 25 to 55 wt % or 25 to 50 wt %.

Preferably, the weight ratio of the recycled composition with respect to the heterophasic propylene copolymer is 1:3 to 3:1, preferably 1:2 to 2:1, more preferably 1:1 to 2:1.

### (B) Heterophasic Propylene Copolymer

The blended composition according to the present invention comprises a heterophasic propylene copolymer. Preferably, the amount of the heterophasic propylene copolymer with respect to the blended composition according to the invention is 10 to 90 wt %, 15 to 70 wt %, 20 to 60 wt % or 25 to 50 wt %.

The heterophasic propylene copolymer consists of (a1) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (a2) a dispersed ethylene-α-olefin copolymer, wherein the sum of the total amount of propylene-based matrix and total amount of the dispersed ethylene-α-olefin copolymer in the heterophasic propylene copolymer is 100 wt %.

Heterophasic propylene copolymers, also known as impact propylene copolymers or propylene block copolymers, are an important class of polymers due to their attractive combination of mechanical properties, such as impact strength over a wide temperature range and their low cost. These copolymers find a wide range of applications ranging from the consumer industry (for example packaging and housewares), the automotive industry to electrical applications.

Heterophasic propylene copolymers are generally prepared in one or more reactors, by polymerization of propylene in the presence of a catalyst and subsequent polymerization of an ethylene-α-olefin mixture. The resulting polymeric materials are heterophasic, but the specific morphology usually depends on the preparation method and monomer ratios used.

The heterophasic propylene copolymers employed in the present invention can be produced using any conventional technique known to the skilled person, for example multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524.

Preferably, the heterophasic propylene copolymer is made using Ziegler-Natta catalyst.

The heterophasic propylene copolymer may be prepared by a process comprising
polymerizing propylene and optionally ethylene and/or α-olefin in the presence of a catalyst system to obtain the propylene-based matrix and
subsequently polymerizing ethylene and α-olefin in the propylene-based matrix in the presence of a catalyst system to obtain the dispersed ethylene-α-olefin copolymer.

These steps are preferably performed in different reactors. The catalyst systems for the first step and for the second step may be different or same.

The heterophasic propylene copolymer of the composition of the invention consists of a propylene-based matrix and a dispersed ethylene-α-olefin copolymer. The propylene-based matrix typically forms the continuous phase in the heterophasic propylene copolymer. The amounts of the propylene-based matrix and the dispersed ethylene-α-olefin copolymer may be determined by ¹³C-NMR, as well known in the art.

The propylene-based matrix consists of a propylene homopolymer and/or a propylene copolymer consisting of at least 90 wt % of propylene monomer units and at most 10 wt % of comonomer units selected from ethylene monomer units and α-olefin monomer units having 4 to 10 carbon atoms, for example consisting of at least 95 wt % of propylene monomer units and at most 5 wt % of the comonomer units, based on the total weight of the propylene-based matrix.

Preferably, the comonomer in the propylene copolymer of the propylene-based matrix is selected from the group of ethylene, 1-butene, 1-pentene, 4-methyl-1-pentene, 1-hexen, 1-heptene and 1-octene, and is preferably ethylene.

Preferably, the propylene-based matrix consists of a propylene homopolymer. The fact that the propylene-based matrix consists of a propylene homopolymer is advantageous in that a higher stiffness is obtained compared to the case where the propylene-based matrix is a propylene-α-olefin copolymer.

Preferably, the propylene-based matrix of the heterophasic propylene polymer has a melt flow index as determined by ISO1133-1:2011 at 230° C. with 2.16 kg load of 20 to 150 dg/min, preferably from 50 to 100 dg/min, more preferably from 60 to 90 dg/min.

Preferably, the propylene-based matrix is present in an amount of 65 to 81 wt %, preferably 70 to 76 wt %, based on the total heterophasic propylene copolymer.

The propylene-based matrix is preferably semi-crystalline, that is it is not 100% amorphous, nor is it 100% crystalline. For example, the propylene-based matrix is at least 40% crystalline, for example at least 50%, for example at least 60% crystalline and/or for example at most 80% crystalline, for example at most 70% crystalline. For example, the propylene-based matrix has a crystallinity of 60 to 70%. For purpose of the invention, the degree of crystallinity of the propylene-based matrix is measured using differential scanning calorimetry (DSC) according to ISO11357-1 and ISO11357-3 of 1997, using a scan rate of 10° C./min, a sample of 5 mg and the second heating curve using as a theoretical standard for a 100% crystalline material 207.1 J/g.

Besides the propylene-based matrix, the heterophasic propylene copolymer also comprises a dispersed ethylene-α-olefin copolymer. The dispersed ethylene-α-olefin copolymer is also referred to herein as the ‘dispersed phase’. The dispersed phase is embedded in the heterophasic propylene copolymer in a discontinuous form. The particle size of the dispersed phase is typically in the range of 0.05 to 2.0 microns, as may be determined by transmission electron microscopy (TEM). The amount of the dispersed ethylene-α-olefin copolymer in the heterophasic propylene copolymer may herein be sometimes referred as RC.

Preferably, the amount of ethylene monomer units in the ethylene-α-olefin copolymer is 55 to 68 wt %. The amount of ethylene monomer units in the dispersed ethylene-α-olefin copolymer in the heterophasic propylene copolymer may herein be sometimes referred as RCC2.

The α-olefin in the ethylene-α-olefin copolymer is preferably chosen from the group of α-olefins having 3 to 8 carbon atoms. Examples of suitable α-olefins having 3 to 8 carbon atoms include but are not limited to propylene, 1-butene, 1-pentene, 4-methyl-1-pentene, 1-hexen, 1-heptene and 1-octene. More preferably, the α-olefin in the ethylene-α-olefin copolymer is chosen from the group of α-olefins having 3 to 4 carbon atoms and any mixture thereof, more preferably the α-olefin is propylene, in which case the ethylene-α-olefin copolymer is ethylene-propylene copolymer.

The MFI of the dispersed ethylene α-olefin copolymer (before the heterophasic propylene copolymer is mixed into the composition of the invention), MFIrubber, may be for example at least 0.001 dg/min, at least 0.03 dg/min or at least 0.05 dg/min, and/or for example at most 0.1 dg/min or 0.01 dg/min. MFIrubber is calculated according to the following formula:

$$MFIrubber = 10 \hat{} ( \frac{Log MFIheterophasic - matrix content * Log MFImatrix}{rubber content} )$$

wherein MFIheterophasic is the MFI (dg/min) of the heterophasic propylene copolymer measured according to ISO1133-1:2011 (2.16 kg/230° C.), MFImatrix is the MFI (dg/min) of the propylene-based matrix measured according to ISO1133-1:2011 (2.16 kg/230° C.), matrix content is the fraction of the propylene-based matrix in the heterophasic propylene copolymer, rubber content is the fraction of the dispersed ethylene-α-olefin copolymer in the heterophasic propylene copolymer. The sum of the matrix content and the rubber content is 1. For the avoidance of any doubt, Log in the formula means log₁₀.

Preferably, the dispersed ethylene-α-olefin copolymer is present in an amount of 19 to 35 wt %, preferably 24 to 30 wt %, based on the total heterophasic propylene copolymer.

In the heterophasic propylene copolymer in the composition of the invention, the sum of the total weight of the propylene-based matrix and the total weight of the dispersed ethylene-α-olefin copolymer is 100 wt % of the heterophasic propylene copolymer.

The heterophasic propylene copolymer can be divided into a xylene-soluble part (CXS) and a xylene-insoluble part (CXI). Preferably, the heterophasic propylene copolymer has a fraction soluble in p-xylene at 25° C. (CXS) measured according to ISO 16152:2005 of 12 to 27 wt %, preferably in the range from 16 to 25 wt %, more preferably in the range from 18 to 23 wt %.

Preferably, in the heterophasic propylene copolymer according to the invention, the comonomer in the propylene-α-olefin copolymer is selected from ethylene and the group of α-olefins having 4 to 10 carbon atoms and the α-olefin in the ethylene-α-olefin copolymer is selected from the group of α-olefins having 3 to 8 carbon atoms. Most preferably, in the heterophasic propylene copolymer according to the invention, the comonomer in the propylene-α-olefin copolymer is ethylene and the α-olefin in the ethylene-α-olefin copolymer is propylene.

The values of the MFI of the propylene-based matrix (MFImatrix) and the MFI of the dispersed ethylene-α-olefin elastomer (MFIrubber) mentioned herein are understood as the values before the heterophasic propylene copolymer is mixed with other components to obtain the composition according to the invention.

The value of the MFI of the heterophasic propylene copolymer (MFIheterophasic) refers to the final MFI of the heterophasic propylene copolymer. To exemplify this: In case the heterophasic propylene copolymer is not subjected to vis-breaking or shifting by melt-mixing with a peroxide, the MFIheterophasic is the original MFI value of the heterophasic propylene copolymer. In case the heterophasic propylene copolymer is subjected to vis-breaking or shifting by melt-mixing with a peroxide, the MFIheterophasic is the value of the heterophasic propylene copolymer after such vis-breaking or shifting.

Preferably, the xylene soluble part of the heterophasic propylene copolymer has an intrinsic viscosity as determined by ISO1628-1:2009 in decalin at 135° C. of 2.9 to 4.6 dl/g, more preferably from 3.5 to 4.4 dl/g, even more preferably from 3.8 to 4.2 dl/g.

The heterophasic propylene copolymer in the composition according to the invention has a melt flow index as measured according to ISO1133-1:2011 (2.16 kg/230° C.) of 5.6 to 65 dg/min, preferably 7.1 to 53 dg/min, more preferably 10.3 to 39 dg/min, more preferably 12.5 to 27 dg/min.

The heterophasic propylene copolymer is preferably a reactor grade heterophasic propylene copolymer.

### (C) Inorganic Filler

The blended composition according to the present invention further comprises an inorganic filler.

Suitable examples of inorganic fillers include but are not limited to talc, calcium carbonate, wollastonite, barium sulfate, kaolin, glass flakes, glass fibers, laminar silicates (bentonite, montmorillonite, smectite) and mica and mixtures thereof.

For example, the inorganic filler is chosen from the group of talc, calcium carbonate, wollastonite, mica and mixtures thereof. More preferably, the inorganic filler is talc.

The mean particle size of talc (D50) of talc is preferably in the range from 0.1 to 10.2 micron, preferably from 0.3 to 8.1 micron, more preferably from 0.5 to 5.2 micron, even more preferably from 0.6 to 2.5 micron according to sedimentation analysis, Stokes' law (ISO 13317-3:2001).

Preferably, the amount of the inorganic filler with respect to the blended composition is 1.0 to 30 wt %, more preferably 5.0 to 27 wt %, more preferably 10 to 25 wt %, more preferably 15 to 23 wt %.

Preferably, the total of (A), (B) and (C) with respect to the blended composition is at least 90 wt %, at least 95 wt %, at least 98 wt %, at least 99 wt % or 100 wt %.

### (D) Additives

The blended composition according to the present invention may further contain additives, for instance nucleating agents and clarifiers, stabilizers, release agents, plasticizers, anti-oxidants, lubricants, anti-statics, cross linking agents, scratch resistance agents, high performance fillers, pigments and/or colorants, flame retardants, blowing agents, acid scavengers, recycling additives, anti-microbials, anti-fogging additives, slip additives, anti-blocking additives, polymer processing aids and the like. Such additives are well known in the art. The amount of the additives is preferably at least 0.1 wt % and at most 5.0 wt %, preferably at most 4.5 wt %, preferably at most 4.0 wt %, more preferably at most 3.8 wt % based on the total amount of the blended composition.

Preferably, the total of (A), (B), (C) and (D) with respect to the blended composition is 100 wt %.

### Further Aspects

The invention further relates to an article comprising the composition according to the invention, preferably wherein the article is an automotive part, preferably wherein the amount of the polymer composition according to the present invention is at least 95 wt %, preferably at least 98 wt % based on the total amount of the article.

Preferably, the automotive part is selected from the group consisting of exterior visible and partly visible applications, like bumper fascias, rocker panels, trims, cowl tops, cowl vent grill, windshield plenum and under-the-hood applications, like head-lamp housings.

The invention further relates to a composition comprising (A) a recycled composition obtained by processing a waste plastic material derived from post-consumer and/or post-industrial waste, (B) a heterophasic propylene copolymer and (C) an inorganic filler,
wherein the heterophasic propylene copolymer consists of (a1) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (a2) a dispersed ethylene-α-olefin copolymer, wherein the sum of the total amount of propylene-based matrix and total amount of the dispersed ethylene-α-olefin copolymer in the heterophasic propylene copolymer is 100 wt %,
the heterophasic propylene copolymer has a xylene soluble part with respect to the heterophasic propylene copolymer as determined by ISO16152:2005 of 12 to 27 wt % and
the heterophasic propylene copolymer has a melt flow index as determined by ISO1133-1:2011 at 230° C. with 2.16 kg load of 5.6 to 65 dg/min,
wherein the recycled composition comprises a propylene-based polymer at an amount of at least 90 wt % with respect to the recycled composition,
the recycled composition has an ash content of less than 10 wt % with respect to the recycled composition,
the recycled composition has a melt flow index as determined by ISO1133-1:2011 at 230° C. with 2.16 kg load of 15 to 100 dg/min,
the recycled composition has an Izod impact strength as determined by ISO180/1A (parallel) at 23° C. of 2.0 to 5.0 kJ/m2 and
the recycled composition has a flexural modulus as determined by ISO178 (parallel) at 23° C. of 1500 to 2000 MPa.

The invention further relates to use of (A) a recycled composition obtained by processing a waste plastic material derived from post-consumer and/or post-industrial waste for improving tiger stripe performance of a composition comprising (B) a heterophasic propylene copolymer and (C) an inorganic filler,
wherein the heterophasic propylene copolymer consists of (a1) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (a2) a dispersed ethylene-α-olefin copolymer, wherein the sum of the total amount of propylene-based matrix and total amount of the dispersed ethylene-α-olefin copolymer in the heterophasic propylene copolymer is 100 wt %,
the heterophasic propylene copolymer has a xylene soluble part with respect to the heterophasic propylene copolymer as determined by ISO16152:2005 of 12 to 27 wt % and
the heterophasic propylene copolymer has a melt flow index as determined by ISO1133-1:2011 at 230° C. with 2.16 kg load of 5.6 to 65 dg/min,
wherein the recycled composition comprises a propylene-based polymer at an amount of at least 90 wt % with respect to the recycled composition,
the recycled composition has an ash content of less than 10 wt % with respect to the recycled composition,
the recycled composition has a melt flow index as determined by ISO1133-1:2011 at 230° C. with 2.16 kg load of 15 to 100 dg/min,
the recycled composition has an Izod impact strength as determined by ISO180/1A (parallel) at 23° C. of 2.0 to 5.0 kJ/m2 and
the recycled composition has a flexural modulus as determined by ISO178 (parallel) at 23° C. of 1500 to 2000 MPa.

It is noted that the invention relates to the subject-matter defined in the independent claims alone or in combination with any possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

The invention is now elucidated by way of the following examples, without however being limited thereto.

### Materials Used

IPC1: a heterophasic copolymer having MFI (ISO1133-1:2011, 230° C., 2.16 kg) of 14 dg/min consisting of a matrix of a propylene homopolymer (74 wt %) and a dispersed phase of a propylene-ethylene copolymer with the following properties. The matrix has MFI (ISO1133-1:2011, 230° C., 2.16 kg) of 85 dg/min.

| | |
|---|---|
| CXS (wt %) | 22 |
| IV_{CXS} (dl/g) | 4 |
| IV_{CXI} (dl/g) | 1.4 |
| IV_{CXS}/IV_{CXI} | 2.9 |

Weight percentage of the xylene-soluble part (CXS) of the heterophasic propylene copolymers was determined according to ISO16152:2005. Weight percentage of xylene-insoluble part (CXI) of the heterophasic propylene copolymers was calculated using the following equation:

CXI=100 wt %−CXS

Both xylene-soluble and xylene-insoluble parts (CXS and CXI) obtained in this test were used in the intrinsic viscosity (IV) test.

Intrinsic viscosity (IV) of CXS and CXI was determined according to ISO1628-1:2009 and ISO1628-3:2010 respectively in decalin at 135° C.

homoPP1: a propylene homopolymer having MFI (ISO1133-1:2011, 230° C., 2.16 kg) of 5.8 dg/min

Talc: Luzenac 1445 commercially available from Imerys Talc. The mean particle size of talc (D50) of Luzenac 1445 is 10 micron as measured according to sedimentation analysis, Stokes' law (ISO 13317-3:2001).

Stabilizers: standard additives such as antioxidants, heat stabilizers, mold release agents, UV stabilizers, process stabilizers

Various properties of Recycled PP1 and Recycled PP2 and homoPP1 are shown in Table 1:

TABLE 1

| | Recycled PP1 | Recycled PP2 | homoPP1 |
|---|---|---|---|
| Source | Obtained by | Recycled from first | Virgin PP |
| | washing and | class industrial non | |
| | griding | woven. The non | |
| | post-industrial | woven itself is | |
| | waste | processed from raw | |
| | of propylene | material which is | |
| | homopolymer | 93% virgin high | |
| | | quality PP | |
| | | homopolymer | |
| | | and 7% PE. Cut, | |
| | | mixed & granulated | |
| Ash content | 0 | 6.3 | 0 |
| [wt %] | | | |
| MFI [g/10 min] | 23 | 29 | 5.8 |
| Izod impact @ | 2.9 | 2.9 | 3.5 |
| 23° C. [kJ/m²] | | | |
| Izod impact @ | 1.4 | 2 | |
| 0° C. [kJ/m²] | | | |
| Flexural modulus | 1850 | 1745 | 1800 |
| [MPa] | | | |
| Flexural strength | 50 | 44 | 46 |
| [MPa] | | | |
| Melting point [° C.] | 140-150 | | |
| Density [g/cm³] | 0.8-0.9 | | |

Components shown in Table 1 were melt-mixed and compositions of CEx 1, Ex 2 and Ex 3 were obtained. The properties were measured and are shown in Table 2.

TABLE 2

| | CEx 1 | Ex 2 | Ex 3 |
|---|---|---|---|
| IPC1 | 78.8 | 28.8 | 30 |
| recycled PP1 | | 50 | 12.5 |
| recycled PP2 | | | 12.5 |
| homoPP1 | | | 23.8 |
| talc1 | 19 | 19 | 19 |
| Stabilizers | 1.2 | 0.1 | 0.1 |
| Masterbatch PE 4884 | 1 | 1 | 1 |
| (Standard Black) | | | |
| Testing results | | | |
| Ash content [wt %] | | 18.2 | 20 |
| MFI [g/10 min] | 10 | 19 | 14.1 |
| Average Tiger stripe | | 8.4 | 6.5 |
| rating (0: worst, 10: best) | | | |

It can be understood from Ex 2 and Ex 3 that the use of a recycled polypropylene results in better aesthetic properties than the use of a virgin propylene homopolymer having a lower MFI.

For CEx 1, average tiger stripe rating worse than Ex 3 is noted.

Ash content was measured according to ISO 3451.

Melt flow index (MFI) was measured according to ISO1133-1:2011 at 230° C. with a 2.16 kg load.

Izod impact strength was determined by ISO180/1A (parallel) at 23° C. and 0° C.

Flexural modulus and flexurel strength were determined by ISO178 (parallel) at 23° C.

Melting point was determined by DSC at standard protocol from −100° C. to 200° C. @10° C./min with purge flow of 50 ml/min Nitrogen.

Density was measured according to ISO 1183.

### Tiger Stripe (TS) Evaluation

The pellets of the compositions were injection moulded into ruler-shaped test specimens. After molding, each of the specimens was visually observed for occurrence of tiger stripes on its smooth side and textured side. The quality of the surface was evaluated on a scale of 1 to 10, 10 being the best.

| TS | |
|---|---|
| score | description |
| 1 | *very sharp transitions between glossy and dull sections visible |
| | seen from any angle |
| 2 | *sharp transitions between glossy and dull sections seen from any |
| | angle |
| 3 | very visible transitions between glossy and dull sections seen from |
| | any angle |
| 4 | visible transitions between glossy and dull sections seen from any |
| | angle |
| 5 | less visible transitions between glossy and dull sections seen from |
| | any angle |
| 6 | visible transitions between glossy and dull sections seen from a |
| | specific angle only |
| 7 | less visible transitions between glossy and dull sections seen from a |
| | specific angle only |
| 8 | no transitions between glossy and dull sections visible and surface |
| | appearance inhomogeneous |
| 9 | no transitions between glossy and dull sections visible and surface |
| | appearance homogeneous |
| 10 | no transitions between glossy and dull sections visible and surface |
| | is perfect |

The average tiger stripe rating is defined as the numerical average of the individual tiger stripe ratings for each of the test specimens manufactured at low, medium and high speed, at low, medium and high temperature, manufactured with the pin-gate and the fan-gate and measured on the smooth and on the textured surface. Hence, the average tiger stripe rating as defined herein is the average of 36 individual tiger stripe measurements.

1. A process for making a blended composition, comprising the steps of:
i) processing a waste plastic material derived from post-consumer and/or post-industrial waste to obtain (A) a recycled composition,
ii) melt-mixing the recycled polypropylene composition with (B) a heterophasic propylene copolymer and (C) an inorganic filler,
wherein the heterophasic propylene copolymer consists of (a1) a propylene-based matrix,
wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (a2) a dispersed ethylene-α-olefin copolymer, wherein the sum of the total amount of propylene-based matrix and total amount of the dispersed ethylene-α-olefin copolymer in the heterophasic propylene copolymer is 100 wt %,
the heterophasic propylene copolymer has a xylene soluble part as determined by ISO16152:2005 in an amount of 12 to 27 wt % and
the heterophasic propylene copolymer has a melt flow index as determined by ISO1133-1:2011 at 230° C. with 2.16 kg load of 5.6 to 65 dg/min,
wherein the recycled composition comprises a propylene-based polymer at an amount of at least 90 wt % with respect to the recycled composition,
the recycled composition has an ash content as determined by ISO 3451 of less than 10 wt % with respect to the recycled composition,
the recycled composition has a melt flow index as determined by ISO1133-1:2011 at 230° C. with 2.16 kg load of 15 to 100 dg/min,
the recycled composition has an Izod impact strength as determined by ISO180/1A (parallel) at 23° C. of 2.0 to 5.0 kJ/m2 and the recycled composition has a flexural modulus as determined by ISO178 (parallel) at 23° C. of 1500 to 2000 MPa.

2. The process according to claim 1, wherein
the amount of the recycled composition with respect to the blended composition is 10 to 90 wt %,
the amount of the heterophasic propylene copolymer with respect to the blended composition is 10 to 90 wt %, and
the amount of the inorganic filler with respect to the blended composition is 1.0 to 30 wt %.

3. The process according to claim 1, wherein the recycled composition with respect to the blended composition is 30 to 70 wt %.

4. The process according to claim 1, wherein the recycled composition has a melt flow index as determined by ISO1133-1:2011 at 230° C. with 2.16 kg load of 20 to 100 dg/min.

5. The process according to claim 1, wherein the ratio of the melt flow index as determined by ISO1133-1:2011 at 230° C. with 2.16 kg load of the recycled composition to the melt flow index as determined by ISO1133-1:2011 at 230° C. with 2.16 kg load of the propylene-based matrix of the heterophasic propylene polymer is 0.1 to 5.0.

6. The process according to claim 1, wherein the xylene soluble part of the heterophasic propylene copolymer has an intrinsic viscosity as determined by ISO1628-1:2009 in decalin at 135° C. of 2.9 to 4.6 dl/g.

7. The process according to claim 1, wherein the propylene-based matrix of the heterophasic propylene polymer has a melt flow index as determined by ISO1133-1:2011 at 230° C. with 2.16 kg load of 20 to 150 dg/min.

8. The process according to claim 1, wherein the propylene-based matrix is present in an amount of 65 to 81 wt %, based on the total heterophasic propylene copolymer and the amount of ethylene monomer units in the ethylene-α-olefin copolymer in the heterophasic propylene copolymer is 55 to 68 wt %.

9. A process for preparing an article, comprising the process according to claim 1 and the step of injection molding the blended composition to obtain the article.

10. The process according to claim 9, wherein the article is an automotive part.

11. The blended composition obtained by the process according to claim 1.

12. An article comprising the blended composition according to claim 11.

13. The article according to claim 12, wherein the article is an automotive part.

14. A composition comprising (A) a recycled composition obtained by processing a waste plastic material derived from post-consumer and/or post-industrial waste, (B) a heterophasic propylene copolymer and (C) an inorganic filler,
wherein the heterophasic propylene copolymer consists of (a1) a propylene-based matrix, wherein the propylene-based matrix consists of a propylene homopolymer and/or a propylene copolymer consisting of at least 90 wt % of propylene monomer units and at most 10 wt % of ethylene and/or α-olefin monomer units, based on the total weight of the propylene-based matrix and (a2) a dispersed ethylene-α-olefin copolymer, wherein the sum of the total amount of propylene-based matrix and total amount of the dispersed ethylene-α-olefin copolymer in the heterophasic propylene copolymer is 100 wt %,
the heterophasic propylene copolymer has a xylene soluble part with respect to the heterophasic propylene copolymer as determined by ISO16152:2005 of 12 to 27 wt % and
the heterophasic propylene copolymer has a melt flow index as determined by ISO1133-1:2011 at 230° C. with 2.16 kg load of 5.6 to 65 dg/min,
wherein the recycled composition comprises a propylene-based polymer at an amount of at least 90 wt % with respect to the recycled composition,
the recycled composition has an ash content of less than 10 wt % with respect to the recycled composition,
the recycled composition has a melt flow index as determined by ISO1133-1:2011 at 230° C. with 2.16 kg load of 15 to 100 dg/min,
the recycled composition has an Izod impact strength as determined by ISO180/1A (parallel) at 23° C. of 2.0 to 5.0 kJ/m2 and the recycled composition has a flexural modulus as determined by ISO178 (parallel) at 23° C. of 1500 to 2000 MPa.

15. (canceled)
